(19) United States
(12) Patent Application Publication
(10) Pub. No.: US 2018/0329239 A1
(43) Pub. Date: Nov. 15, 2018

(54) DISPLAY DEVICE AND METHOD FOR PRODUCING DISPLAY DEVICE

(71) Applicant: Sakai Display Products Corporation, Osaka (JP)

(72) Inventors: Hiroki FUKAI, Sakai-shi (JP); Nobuo OKANO, Sakai-shi (JP); Yukio YOSHIDA, Sakai-shi (JP)

(73) Assignee: Sakai Display Products Corporation, Osaka (JP)

(21) Appl. No.: 15/777,143

(22) PCT Filed: Nov. 19, 2015
(86) PCT No.: PCT/JP2015/082613

§ 371 Date: May 17, 2018

(51) Int. Cl. G02F 1/1333; G02F 1/1335

(52) U.S. Cl. CPC G02F 1/1333; G02F 1/133528; G02F 2001/133354; G02F 2202/28; G02F 2201/56; G02F 2001/133302

(57) ABSTRACT

The purpose of the present invention is to provide a display device wherein offsetting of substrates with each other in a liquid crystal panel by force applied during curve formation can be suppressed and thereby display defects can be reduced, and a method for manufacturing the display device. Provided is a display device that is provided with a curved liquid crystal panel comprising a pair of glass substrates that are made to face each other with liquid crystals encapsulated therebetween, said display device being provided with a translucent sheet material that is disposed on one surface side, which is the inside of the curve, of the liquid crystal panel, is larger than the liquid crystal panel, and is curved along the liquid crystal panel.

### TECHNICAL FIELD

The present invention relates to a display apparatus that displays an image using a liquid crystal panel. The present invention also relates to a display apparatus that has a configuration including a curved liquid crystal panel and capable of maintaining a good display quality, and to a method for producing the display apparatus.

### BACKGROUND ART

In the field of recent display apparatus, curved displays including curved liquid crystal panels have been in practice. Preventing defects due to separation, distortion, misalignment, and the like of and between components has been a challenge in production of such curved displays.

Patent Literature 1 discloses a production method of a curved display. According to this production method, an acrylic or polycarbonate front supporting substrate is first placed on a semi-cylindrically shaped support having a curved surface (such as a side surface of a cylindrical product), and the front supporting substrate is preliminarily curved along the curved surface of the support. Next, an adhesive layer is formed on the curved front supporting substrate, and a liquid crystal panel including glass substrates is placed on the adhesive layer. The liquid crystal panel is attached to the adhesive layer by a certain process such as roller compression bonding or vacuum compression bonding thereby to curve the liquid crystal panel. Patent Literature 1 further discloses the following. A back supporting substrate is placed on the liquid crystal panel and curved along the liquid crystal panel. The front supporting substrate and the back supporting substrate are screwed to each other so as to hold the liquid crystal panel therebetween thereby to retain the curved surface of the liquid crystal panel.

### CITATION LIST

### Patent Literature

### [Patent Literature 1]

Japanese Patent Application Laid-Open Publication No. 2011-085740

### SUMMARY OF INVENTION

### Technical Problem

A liquid crystal panel includes a glass substrate provided with thin film transistors (TFTs) and a glass substrate provided with color filters (CFs), which are bonded with a photocurable adhesive. The glass substrates are each bonded in a narrow bonding region along a perimeter thereof. Such a bonding region accounts for a smaller percentage of an overall substrate surface particularly in a larger display apparatus. In a liquid crystal panel that is curved alone, glass substrates easily exert force to stretch outward along a curved shape thereof. Besides, the two glass substrates may stretch non-uniformly due to a difference in curvature therebetween. In such a situation, the two glass substrates may become misaligned relative to each other.

Conventional production methods of curved displays including the method disclosed in Patent Literature 1 are to curve and thus deform components sequentially on a component-by-component basis. The invention disclosed in Patent Literature 1 successfully reduces an effect of stress that develops due to the curved liquid crystal panel returning toward flat, but fails to cope with force that is exerted on non-curved portions of the liquid crystal panel when the liquid crystal panel is curved and thus deformed in the production.

The present invention has been made in view of the circumstances described above, and an object thereof is to provide a display apparatus and a method for producing the display apparatus, according to which it is possible to suppress misalignment of substrates relative to each other in a liquid crystal panel therein due to force exerted when the liquid crystal panel is curved and thus deformed, and thereby to reduce defective display.

### Solution to Problem

A display apparatus according to one embodiment of the present invention includes a curved liquid crystal panel and a transparent plate. The curved liquid crystal panel includes a pair of glass substrates arranged opposed to each other and a liquid crystal enclosed between the glass substrates. The transparent plate is disposed over one surface of the curved liquid crystal panel which faces inward of a curved shape thereof, is larger than the curved liquid crystal panel, and is curved along the curved liquid crystal panel.

The display apparatus according to the embodiment of the present invention further includes additional plates and adhesive layers. The additional plates are respectively disposed over two opposed edge sections on a liquid crystal panel-facing surface of the transparent plate and along edges of the transparent plate, with the curved liquid crystal panel between the transparent plate and the additional plates. The adhesive layers bond sections of the transparent plate to the additional plates. The sections are outside of a region corresponding to the curved liquid crystal panel.

In the display apparatus according to the embodiment of the present invention, the transparent plate is bonded to the one surface of the curved liquid crystal panel.

The display apparatus according to one embodiment of the present invention further includes an additional plate and adhesive layers. The additional plate is disposed over another surface of the curved liquid crystal panel which is opposite to the one surface, has substantially the same size as the transparent plate, and is curved along the curved liquid crystal panel. The adhesive layers bond sections of the transparent plate to the additional plate. The sections are outside of a region corresponding to the curved liquid crystal panel.

In the display apparatus according to the embodiment of the present invention, the transparent plate is more rigid than the curved liquid crystal panel.

A method for producing a display apparatus according to one embodiment of the present invention is a method for producing a display apparatus including a curved liquid crystal panel. The curved liquid crystal panel includes a pair of glass substrates arranged opposed to each other and a liquid crystal enclosed between the glass substrates. The method includes placing, fixing, and curving and thus deforming. In the placing, a liquid crystal panel yet to be curved is placed over a transparent plate larger than the liquid crystal panel. In the fixing, the transparent plate and the liquid crystal panel are fixed to each other. In the curving and thus deforming, the transparent plate and the liquid crystal panel are curved and thus deformed together so that the transparent plate is inside of a curved shape thereof.

According to the embodiment of the present invention, a transparent plate larger than a flat liquid crystal panel is disposed over one surface of the liquid crystal panel which faces inward of a curved shape thereof, and both the liquid crystal panel and the transparent plate are curved together. Drag of the transparent plate, which is curved together with the liquid crystal panel on the inside of the curved shape, restricts force exerted in a stretching direction of the liquid crystal panel upon curving and deforming.

According to the embodiment of the present invention, the transparent plate disposed over the one surface and two additional plates respectively bonded to two opposed edge sections of the transparent plate hold the liquid crystal panel therebetween, and the transparent plate, the additional plates, and the liquid crystal panel are integrated and curved together. Drag of the transparent plate, which is curved together with the liquid crystal panel on the inside of the curved shape, restricts the force exerted in the stretching direction of the liquid crystal panel upon curving and deforming, because the transparent plate functions as an assisting plate in curving and deforming. The force in the stretching direction is further restricted by the additional plates bonded to the edge sections, and force of the liquid crystal panel returning toward flat is also restricted by the additional plates.

According to the embodiment of the present invention, the transparent plate disposed over the one surface is bonded to the curved liquid crystal panel. Also in a configuration in which the transparent plate is bonded to the liquid crystal panel, drag of the transparent plate, which is curved together with the liquid crystal panel on the inside of the curved shape, restricts the force exerted in the stretching direction of the liquid crystal panel upon curving and deforming, because the liquid crystal panel is integrated with the transparent plate before curving and deforming.

According to the embodiment of the present invention, the transparent plate disposed over the one surface and an additional plate having substantially the same size as the transparent plate hold edge sections of the liquid crystal panel therebetween, and thus the transparent plate, the additional plate, and the liquid crystal panel are integrated and curved together. Drag of the transparent plate, which is curved together with the liquid crystal panel, restricts the force exerted in the stretching direction of the liquid crystal panel upon curving and deforming, because the transparent plate functions as an assisting plate in curving and deforming. The force in the stretching direction is further restricted by the additional plate bonded to the sections of the transparent plate, which are outside of the region corresponding to the liquid crystal panel, and force of the liquid crystal panel returning toward flat is also restricted by the additional plate.

According to the embodiment of the present invention, the liquid crystal panel, which is originally flat, is joined to the transparent plate, which functions as an assisting plate, before being curved and deformed. Drag of the transparent plate, which is curved together with the liquid crystal panel on the inside of the curved shape, restricts the force exerted in the stretching direction of the liquid crystal panel, because the transparent plate and the liquid crystal panel that have been joined are curved and thus deformed together. It is more preferable to form an assisting plate as an optical member using a transparent material and include the assisting plate as a component of the display apparatus than to use and later remove a plate functioning as an assisting plate.

### Advantageous Effects of Invention

According to the embodiment of the present invention, the force that is exerted in the stretching direction of the liquid crystal panel upon curving and deforming is restricted, and thus misalignment of the pair of glass substrates of the liquid crystal panel relative to each other is suppressed. It is therefore possible to maintain the display quality of the display apparatus.

### BRIEF DESCRIPTION OF DRAWINGS

FIG. 1 is a perspective view illustrating main components of a display apparatus according to Embodiment 1.

FIG. 2 is a diagram illustrating a step for curving and thus deforming a liquid crystal panel according to Embodiment 1.

FIG. 3 is a diagram illustrating a step for curving and thus deforming the liquid crystal panel according to Embodiment 1.

FIG. 4 is a diagram illustrating a step for curving and thus deforming the liquid crystal panel according to Embodiment 1.

FIG. 5 is a diagram illustrating force exerted on an end of the liquid crystal panel.

FIG. 6 is a schematic diagram illustrating misalignment of a CF substrate and a TFT substrate relative to each other.

FIG. 7 is a perspective view illustrating a portion of a display apparatus according to Embodiment 2.

FIG. 8 is a diagram illustrating a step for curving and thus deforming the liquid crystal panel according to Embodiment 2.

FIG. 9 is a diagram illustrating a step for curving and thus deforming the liquid crystal panel according to Embodiment 2.

FIG. 10 is a diagram illustrating a step for curving and thus deforming the liquid crystal panel according to Embodiment 2.

FIG. 11 is a perspective view illustrating a portion of a display apparatus according to Embodiment 3.

FIG. 12 is a diagram illustrating a step for curving and thus deforming the liquid crystal panel according to Embodiment 3.

FIG. 13 is a diagram illustrating a step for curving and thus deforming the liquid crystal panel according to Embodiment 3.

FIG. 14 is a diagram illustrating a step for curving and thus deforming the liquid crystal panel according to Embodiment 3.

### DESCRIPTION OF EMBODIMENTS

The following describes embodiments of the present invention in detail based on the drawings. It is to be understood that the embodiments described below are merely examples and the present invention is not limited to configurations described below.

### Embodiment 1

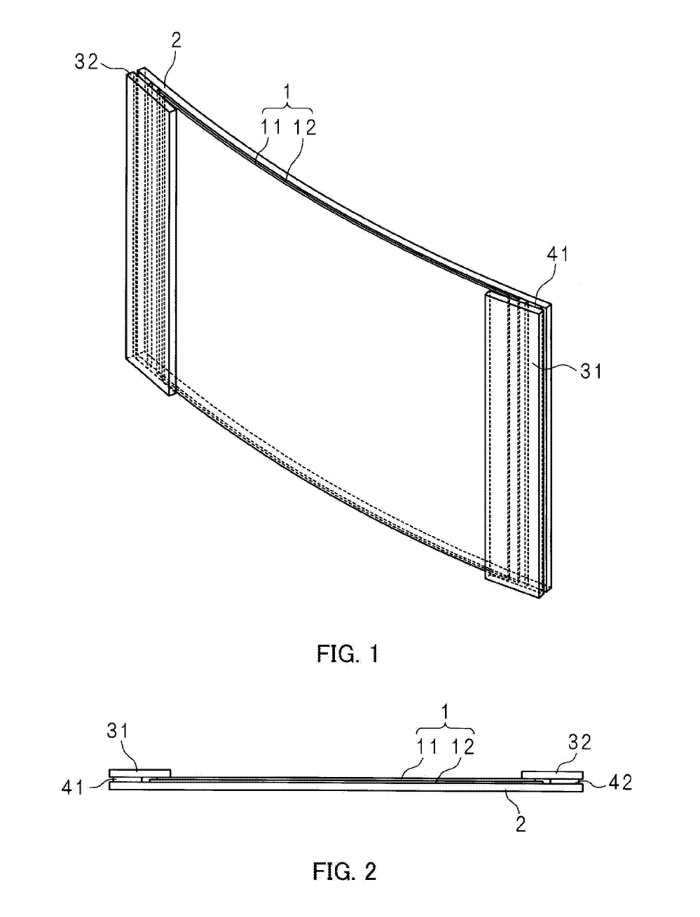

FIG. 1 is a perspective view illustrating main components of a display apparatus according to Embodiment 1. The display apparatus includes a liquid crystal panel 1, a transparent plate 2, and fixing members 31 and 32. The display apparatus further includes other components, not shown, such as a light source, a retaining member, and a housing in addition to the liquid crystal panel 1.

The liquid crystal panel 1 has a shape obtained by curving a flat rectangular plate in a long side direction thereof such that a display surface (near-side surface in FIG. 1) of the liquid crystal panel 1 is a convex. The liquid crystal panel 1 employs an active matrix drive scheme. The liquid crystal panel 1 includes a pair of transparent glass substrates. One of the glass substrates is a TFT substrate 12 provided with pixel electrodes for driving the liquid crystal, elements such as transistors and supplemental capacitors connected to the pixel electrodes, and bus lines for transmitting control signals. The other glass substrate is a CF substrate 11 provided with color filters, a black matrix, and counter electrodes. The liquid crystal panel 1 is prepared by arranging the CF substrate 11 and the TFT substrate 12 opposed to each other with a predetermined space therebetween, injecting a liquid crystal material including liquid crystal molecules into the space, and sealing the space with a seal material. A length of the CF substrate 11 in a long side direction thereof is slightly shorter than that of the TFT substrate 12. The liquid crystal panel 1 also includes polarizing plates preliminarily bonded thereto at a display surface and an opposite surface of the liquid crystal panel 1.

The transparent plate 2 is obtained by curving a flat rectangular elastic transparent plate, such as an acrylic flat plate, in a long side direction thereof. The transparent plate 2 is larger than the liquid crystal panel 1. Preferably, an optical member such as a brightness enhancement film (BEF) and a diffuser sheet, not shown, is provided between the transparent plate 2 and the liquid crystal panel 1. A diffuser layer may be formed over a substantially entire surface, except a portion along a perimeter, of the transparent plate 2 to further provide some functions of an optical sheet disposed at a back surface of the liquid crystal panel. The transparent plate 2 is thicker than the liquid crystal panel 1. This is because the transparent plate 2 is preferably more rigid than the liquid crystal panel 1. For example, the liquid crystal panel 1 has a thickness of approximately 1 mm, and the transparent plate 2 has a thickness of approximately 2 mm. The transparent plate 2 may have the same thickness as the liquid crystal panel 1 as long as the transparent plate 2 is designed to be rigid enough to withstand a curvature radius of a desired curve and to restrict the liquid crystal panel 1 from being wavy when curved.

The fixing members 31 and 32 are obtained by curving flat rectangular plates of the same material as a base material of the transparent plate 2 or of a material that is more rigid than the base material of the transparent plate 2. A length of the fixing members 31 and 32 in a long side direction thereof is substantially equal to a length of the transparent plate 2 in a short side direction thereof. A length of the fixing members 31 and 32 in a short side direction thereof is slightly longer than a half of a difference between a length of the liquid crystal panel 1 in the long side direction thereof and a length of the transparent plate 2 in the long side direction thereof. The fixing members 31 and 32 are respectively bonded through adhesive layers 41 and 42 such that one of long sides of each fixing member is along either of short sides of the transparent plate 2. In such an arrangement, each of the fixing members 31 and 32 overlaps the liquid crystal panel 1 in a portion including the other of the long sides. Preferably, the adhesive layers 41 and 42 are of a material that remains stretchable after curing.

The display apparatus has a configuration in which the light source is disposed facing the liquid crystal panel 1, the transparent plate 2, and the fixing members 31 and 32, which are curved as described above, so as to face the transparent plate 2, and the housing and the retaining member house and retain the liquid crystal panel 1, the transparent plate 2, the fixing members 31 and 32, and the light source. Preferably, the retaining member retains the components while keeping the liquid crystal panel 1 and the light source in positions with a predetermined distance therebetween, and the housing surrounds the liquid crystal panel 1 so as to cover a perimeter and expose a display region.

The following describes steps for curving and thus deforming the liquid crystal panel 1 illustrated in FIG. 1. FIGS. 2 to 4 are diagrams illustrating the steps for curving and thus deforming the liquid crystal panel 1 according to Embodiment 1.

(1) Integration of Liquid Crystal Panel 1 with Transparent Plate 2

In production of the display apparatus according to Embodiment 1, the liquid crystal panel 1 is first integrated with the transparent plate 2.

FIG. 2 is a side view of the liquid crystal panel 1 and the transparent plate 2 before curving and deforming. FIG. 2 shows the liquid crystal panel 1 and the transparent plate 2 taken from a long-side view. An optical member such as a BEF is placed on a central section of the transparent plate 2, and then the liquid crystal panel 1 is placed over the central section such that the TFT substrate 12 of the liquid crystal panel 1 faces the optical member. Next, the adhesive layers 41 and 42 are respectively formed on opposed short side sections of the transparent plate 2, which are outside of the liquid crystal panel 1. Preferably, the adhesive layers 41 and 42 are formed so as to have a predetermined distance from the liquid crystal panel 1. Next, the fixing members 31 and 32 are respectively placed on the adhesive layers 41 and 42. The fixing members 31 and 32 are placed such that one of the long sides of each fixing member is along either of the short sides of the transparent plate 2. The transparent plate 2 and the fixing members 31 and 32 are firmly joined through curing of the adhesive layers 41 and 42 to hold opposed short side sections of the liquid crystal panel 1 therebetween, thereby integrating the liquid crystal panel 1 with the transparent plate 2.

(2) Deformation

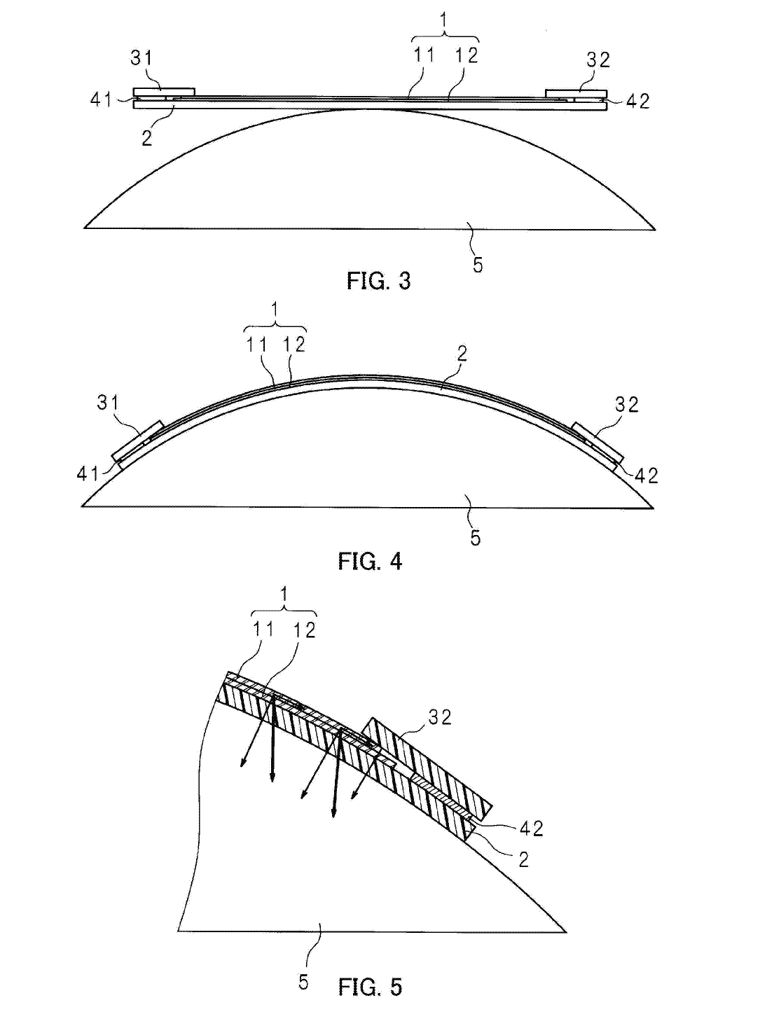

Next, the liquid crystal panel 1, the transparent plate 2, and the fixing members 31 and 32 integrated as described in (1) are curved and thus deformed together. FIG. 3 is a side view of the liquid crystal panel 1 and the transparent plate 2 placed on a base before curving and deforming. The reference sign 5 in FIG. 3 indicates the base, which is used for curving and deforming. The base is semi-cylindrical. FIG. 4 is a side view of the liquid crystal panel 1 and the transparent plate 2 on the base after curving and deforming.

The following describes effects produced by curving and thus deforming the liquid crystal panel 1, the transparent plate 2, and the fixing members 31 and 32 together as described above. First, localized stress on the liquid crystal panel 1 can be avoided, because the rigid transparent plate 2 is used as a jig for the liquid crystal panel 1, which is less rigid as employing thin glass substrates for ease of curving. Furthermore, the display apparatus can be formed thinner using a fewer components than a display apparatus formed using and later removing a plate functioning as an assisting plate, because the transparent plate 2 has a function of diffusing light from the light source and is included in the display apparatus as a component.

Integration of the liquid crystal panel 1 with the transparent plate 2 further produces an effect of restricting force that is exerted on ends of the liquid crystal panel 1. FIG. 5 is a diagram illustrating force that is exerted on an end of the liquid crystal panel 1. FIG. 5 is a partial enlarged view of a cross-section of ends of the liquid crystal panel 1, the transparent plate 2, and the fixing members 31 and 32 that have been curved and thus deformed together. Arrows in FIG. 5 represent physical force exerted on some locations. In particular, the thick arrows indicate directions of force exerted on the ends upon curving and deforming. Theoretically, only force toward a curve central axis (central axis of a curved surface of the base 5) is necessary to curve and thus deform the liquid crystal panel 1, the transparent plate 2, and the fixing members 31 and 32. However, force that is exerted on the ends in the directions indicated by the thick arrows should not be neglected in the step described in (2) of placing the integrated components including the liquid crystal panel 1 on the base 5 as illustrated in FIG. 3 and deforming the same at opposite ends. The force exerted on the ends generates a force component toward the curve central axis for the deformation and a force component in a direction for the liquid crystal panel 1 to stretch outward in the long side direction thereof. According to Embodiment 1, the liquid crystal panel 1 is curved and thus deformed together with the transparent plate 2 and the fixing members 31 and 32, during which the transparent plate 2 functions as an assisting plate in curving and deforming, and drag thereof restricts the force in the outward stretching direction. The force in the stretching direction is further restricted by the fixing members 31 and 32, and force of the liquid crystal panel 1 returning toward flat is also restricted by the fixing members 31 and 32. Thus, misalignment of the CF substrate 11 and the TFT substrate 12 relative to each other in the liquid crystal panel 1 is restricted.

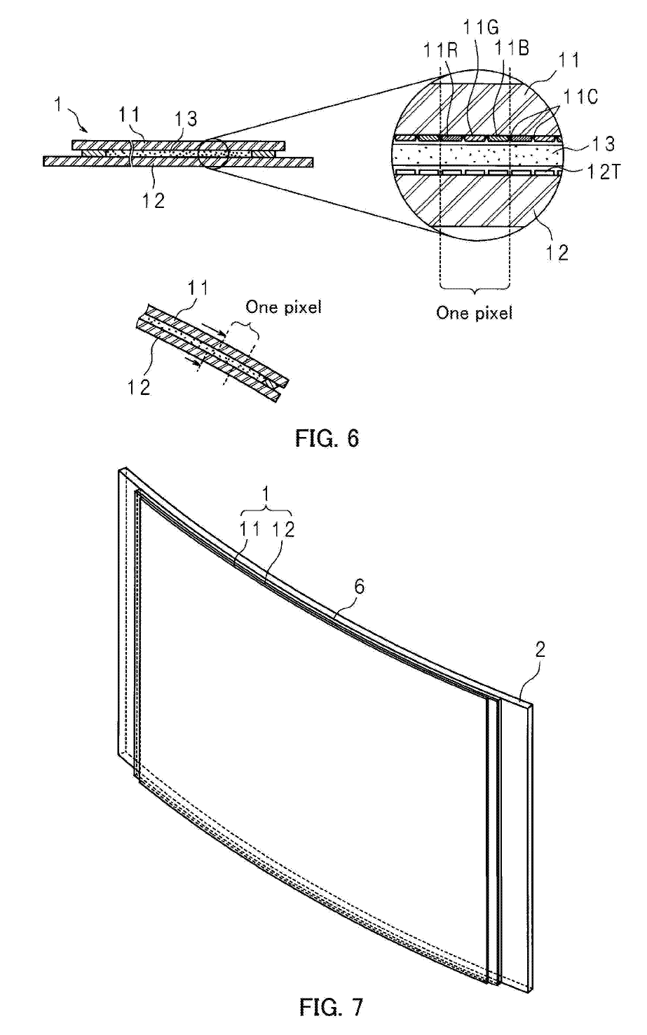

FIG. 6 is a schematic diagram illustrating misalignment of the CF substrate 11 and the TFT substrate 12 relative to each other. FIG. 6 shows an enlarged view of a cross-section of the liquid crystal panel 1 and shows, in a lower section, a schematic view of the misalignment. As illustrated in the enlarged view in FIG. 6, a liquid crystal 13 is enclosed in a space having a predetermined distance between the CF substrate 11 and the TFT substrate 12T in the liquid crystal panel 1. As illustrated in the enlarged view in FIG. 6, the TFT substrate 12, which is one of the substrates arranged opposed to each other with the liquid crystal 13 therebetween, is provided with pixel electrodes 12T formed so as to correspond to subpixels of a plurality of colors (red (R), green (R), and blue (B)) included in each pixel. The other substrate, i.e., the CF substrate 11, is provided with a black matrix 11C and color filters 11R, 11G, and 11B located opposed to the respective pixel electrodes 12T. It is difficult to keep a good display quality in the liquid crystal panel 1 that is curved and thus deformed unless such an opposing relationship is kept between the pixel electrodes 12 and the color filters 11R, 11G, and 11B with the liquid crystal 13 therebetween. However, as described above, force in the direction for the liquid crystal panel 1 to stretch outward in the long side direction thereof is exerted both on the CF substrate 11 and on the TFT substrate 12 upon curving and deforming. As indicated in the lower section of FIG. 6, a magnitude of the force in the stretching direction exerted on the CF substrate 11 and a magnitude of the force in the stretching direction exerted on the TFT substrate 12 may be different due to a difference in curvature radius therebetween. Unlike Embodiment 1, in a configuration that does not include the transparent plate 2 functioning as an assisting plate and that is not able to restrict the force in the stretching direction, the pixel electrodes 12T and the color filters 11R, 11G, and 11B, which should be in the opposing relationship, become misaligned relative to each other as illustrated in the lower section of FIG. 6.

According to the configuration of Embodiment 1, as described above, the transparent plate 2 functions as an assisting plate in curving and deforming, so that localized stress on the liquid crystal panel 1 can be avoided when curving the thin liquid crystal panel 1. Furthermore, drag of the assisting plate restricts force that is exerted in the stretching direction of the liquid crystal panel 1 and that is exerted on the ends of the liquid crystal panel 1. Thus, misalignment of the CF substrate 11 and the TFT substrate 12 relative to each other in the liquid crystal panel 1 is prevented. It is therefore possible to maintain the display quality in the liquid crystal panel 1.

### Embodiment 2

FIG. 7 is a perspective view illustrating a portion of a display apparatus according to Embodiment 2. The display apparatus according to Embodiment 2 includes a liquid crystal panel 1 and a transparent plate 2. The display apparatus further includes other components, not shown, such as a light source, a retaining member, and a housing in addition to the liquid crystal panel 1. The display apparatus according to Embodiment 2 has the same configuration as the display apparatus according to Embodiment 1 other than an element of configuration for fixing the liquid crystal panel 1 to the transparent plate 2. Accordingly, elements of configuration that are shared with the display apparatus according to Embodiment 1 are labelled using the same reference signs, and detailed description thereof is omitted.

The transparent plate 2 according to Embodiment 2 is bonded to a back surface of the liquid crystal panel 1 through an adhesive layer 6. The adhesive layer 6 is formed from a rubber-based adhesive that turns or remains transparent and stretchable after curing. The adhesive layer 6 bonds the transparent plate 2 to a region along a perimeter of a TFT substrate 12 of the liquid crystal panel 1. Preferably, the adhesive layer 6 has a thickness approximately equal to that of the liquid crystal panel 1. For example, the adhesive layer 6 has a thickness of at least 1 mm in a configuration in which the liquid crystal panel 1 has a thickness of approximately 1 mm.

The display apparatus according to Embodiment 2 has a configuration in which the light source is disposed facing the liquid crystal panel 1 and the transparent plate 2, which are curved as described above, so as to face the transparent plate 2, and the housing and the retaining member house and retain the liquid crystal panel 1, the transparent plate 2, and the light source.

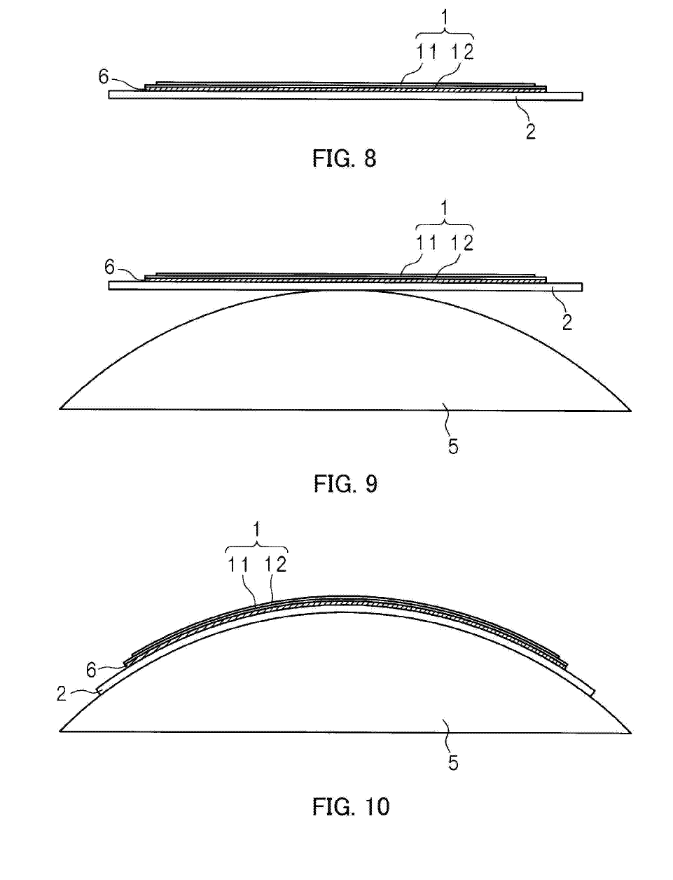

The following describes steps for curving and thus deforming the liquid crystal panel 1 according to Embodiment 2 illustrated in FIG. 7. FIGS. 8 to 10 are diagrams illustrating the steps for curving and thus deforming the liquid crystal panel 1 according to Embodiment 2.

(1) Integration of Liquid Crystal Panel 1 with Transparent Plate 2

Also in production of the display apparatus according to Embodiment 2, the liquid crystal panel 1 is first integrated with the transparent plate 2.

FIG. 8 is a side view of the liquid crystal panel 1 and the transparent plate 2 before curving and deforming. FIG. 8 shows the liquid crystal panel 1 and the transparent plate 2 taken from a long-side view. An optical member such as a BEF is placed on a central section of the transparent plate 2, and then the adhesive layer 6 having a band-like shape is formed so as to surround the optical member along a perimeter of a region corresponding to the TFT substrate 12 to be disposed facing the transparent plate 2. Preferably, the adhesive layer 6 does not adopt face-bonding. This is because face-bonding causes the adhesive layer 6 to exert tension on the TFT substrate 12 upon curving and deforming, which may result in cracked glass. Next, the liquid crystal panel 1 is placed on the adhesive layer 6 with the TFT substrate 12 facing the adhesive layer 6. Through curing of the adhesive layer 6, the liquid crystal panel 1 is integrated with the transparent plate 2. The adhesive layer 6 may alternatively be formed on the TFT substrate 12 before the integration.

(2) Deformation

Next, the liquid crystal panel 1 and the transparent plate 2 integrated as described in (1) are curved and thus deformed together. FIG. 9 is a side view of the liquid crystal panel 1 and the transparent plate 2 placed on a base 5 before curving and deforming. FIG. 10 is a side view of the liquid crystal panel 1 and the transparent plate 2 on the base 5 after curving and deforming.

Also according to Embodiment 2, the liquid crystal panel 1 and the transparent plate 2 that are integrated are curved and thus deformed together. Since the rigid transparent plate 2 is used as a jig, localized stress on the liquid crystal panel 1 can be avoided. Furthermore, the transparent plate 2 functions as an assisting plate in curving and deforming, and drag of the assisting plate restricts force that is exerted in the stretching direction of the liquid crystal panel 1 and that is exerted on the ends of the liquid crystal panel 1. Thus, misalignment of the CF substrate 11 and the TFT substrate 12 relative to each other in the liquid crystal panel 1 is prevented. It is therefore possible to maintain the display quality in the liquid crystal panel 1.

### Embodiment 3

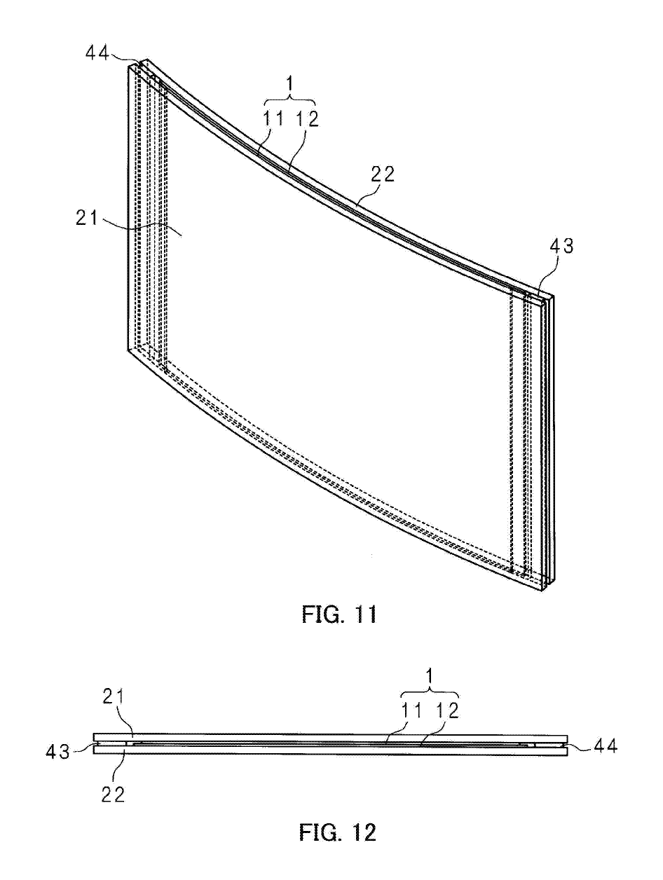

FIG. 11 is a perspective view illustrating a portion of a display apparatus according to Embodiment 3. The display apparatus according to Embodiment 3 includes a liquid crystal panel 1 and transparent plates 21 and 22. The display apparatus further includes other components, not shown, such as a light source, a retaining member, and a housing in addition to the liquid crystal panel 1. The liquid crystal panel 1 in the display apparatus according to Embodiment 3 has the same configuration as the liquid crystal panel 1 according to Embodiment 1. Accordingly, the same reference signs are used and detailed description thereof is omitted.

The transparent plates 21 and 22 are obtained by curving flat transparent rectangular plates in a long side direction thereof. The transparent plates 21 and 22 have substantially the same size as each other and are larger than the liquid crystal panel 1. The transparent plate 21 is for example composed of a highly transparent polymeric material such as poly(methyl methacrylate) (PMMA). The transparent plate 22 also provides some functions of an optical sheet as described below, and therefore may be formed as a diffuser plate by for example dispersing particles having different refractive indices in the polymeric material. The transparent plate 22 may also be formed so as to function as a light guide plate included in a light source. The transparent plates 21 and 22 are thicker than the liquid crystal panel 1. This is because the transparent plates 21 and 22 are preferably more rigid than the liquid crystal panel 1. For example, the liquid crystal panel 1 has a thickness of approximately 1 mm, and the transparent plates 21 and 22 have a thickness of approximately 0.5 to 2 mm. The transparent plates 21 and 22 may have the same thickness as the liquid crystal panel 1 as long as the transparent plates 21 and 22 are designed to be rigid enough to withstand a curvature radius of a desired curve and to restrict the liquid crystal panel 1 from being wavy when curved.

The transparent plates 21 and 22 are arranged with the liquid crystal panel 1 therebetween, and sections of the transparent plates 21 and 22, which are outside of the liquid crystal panel 1, are bonded through adhesive layers 43 and 44. In such an arrangement, a display surface of the liquid crystal panel 1 faces the transparent plate 21. The liquid crystal panel 1 is held between the transparent plates 21 and 22. Preferably, a BEF is disposed between a TFT substrate 12 of the liquid crystal panel 1 and the transparent plate 22.

The display apparatus according to Embodiment 3 has a configuration in which the light source is disposed facing the liquid crystal panel 1 and the transparent plates 21 and 22, which are curved as described above, so as to face the transparent plate 22, and the housing and the retaining member house and retain the liquid crystal panel 1, the transparent plates 21 and 22, and the light source. Preferably, the retaining member retains the components while keeping the liquid crystal panel 1 and the light source in positions with a predetermined distance therebetween, and the housing surrounds the liquid crystal panel 1 so as to cover a perimeter and expose a display region.

The following describes steps for curving and thus deforming the liquid crystal panel 1 illustrated in FIG. 11. FIGS. 12 to 14 are diagrams illustrating the steps for curving and thus deforming the liquid crystal panel 1 according to Embodiment 3.

(1) Integration of Liquid Crystal Panel 1 with Transparent Plates 21 and 22

FIG. 12 is a side view of the liquid crystal panel 1 and the transparent plates 21 and 22 before curving and deforming according to Embodiment 3. FIG. 12 shows the liquid crystal panel 1 and the transparent plates 21 and 22 taken from a long-side view. First, an optical member such as a BEF is placed on a central section of the transparent plate 22, among the transparent plates 21 and 22, and then the liquid crystal panel 1 is placed over the central section such that the TFT substrate 12 of the liquid crystal panel 1 faces the optical member. Next, the adhesive layers 43 and 44 are formed on the sections of the transparent plate 22, which are outside of the liquid crystal panel 1. The adhesive layers 43 and 44 are formed so as to respectively have a predetermined distance from opposed short sides of the liquid crystal panel 1. Opposed short side sections of the transparent plate 21 are placed on the adhesive layers 43 and 44 such that the liquid crystal panel 1 is disposed between the transparent plates 21 and 22. Through curing of the adhesive layers 43 and 44, the liquid crystal panel 1 is held between the transparent plates 21 and 22.

(2) Deformation

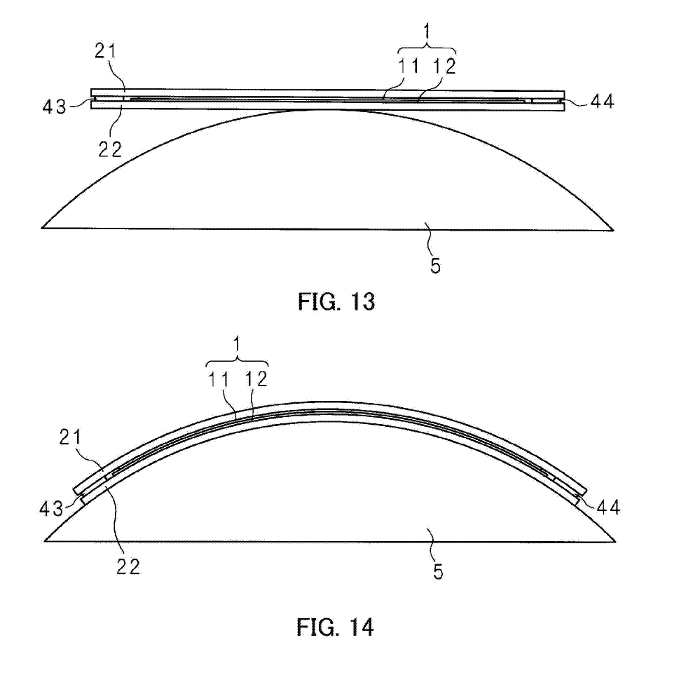

Next, the liquid crystal panel 1 and the transparent plates 21 and 22 integrated as described in (1) are curved and thus deformed together. FIG. 13 is a side view of the liquid crystal panel 1 and the transparent plates 21 and 22 placed on a base 5 before curving and deforming. FIG. 14 is a side view of the liquid crystal panel 1 and the transparent plates 21 and 22 on the base 5 after curving and deforming.

Also according to Embodiment 3, the liquid crystal panel 1 and the transparent plates 21 and 22 that are integrated are curved and thus deformed together. Since the transparent plates 21 and 22 function as assisting plates in curving and deforming, localized stress on the liquid crystal panel 1 can be avoided while curving the thin liquid crystal panel 1. Furthermore, drag of the assisting plates restricts force that is exerted in the stretching direction of the liquid crystal panel 1 and that is exerted on the ends of the liquid crystal panel 1. Furthermore, according to Embodiment 3, the transparent plate 21 restricts opposed short side sections of the liquid crystal panel 1 from separating from the transparent plate 22 due to force of the liquid crystal panel 1 returning toward flat. Thus, misalignment of the CF substrate 11 and the TFT substrate 12 relative to each other in the liquid crystal panel 1 is restricted. It is therefore possible to maintain the display quality in the liquid crystal panel 1.

According to Embodiments 1 to 3, the liquid crystal panel 1 is curved in the long side direction thereof such that the display surface of the liquid crystal panel 1 is a convex. However, the present invention is not limited thereto, and the liquid crystal panel 1 may be curved such that the display surface thereof is a concave, or the liquid crystal panel 1 may be curved in a short side direction thereof.

Note that the presently disclosed embodiments are merely examples in all aspects and should not be construed to be limiting. The scope of the present invention is indicated by the claims, rather than by the description given above, and includes all variations that are equivalent in meaning and scope to the claims.

### REFERENCE SIGNS LIST

1 Liquid crystal panel
11 CF substrate
12 TFT substrate
13 Liquid crystal
2, 21, 22 Transparent plate (plate)
31, 32 Fixing member (plate)
41, 42, 43, 44 Adhesive layer
6 Adhesive layer

1.-6. (canceled)

7. A method for producing a display apparatus including a curved liquid crystal panel, the method comprising:
preparing a flat liquid crystal panel and a flat first plate that is transparent, the flat liquid crystal panel including
a pair of glass substrates opposed to each other and
a liquid crystal enclosed between the pair of glass substrates,
the flat liquid crystal panel having
a first surface serving as a display surface or a back surface and
a second surface being opposite to the first surface,
the flat first plate having a flat surface larger than the first surface of the flat liquid crystal panel;
obtaining a flat integrated member including the flat liquid crystal panel and the flat first plate by placing the flat first plate over the flat liquid crystal panel so that the flat surface covers the entirety of the first surface; and
obtaining a curved integrated member including a curved liquid crystal panel and a curved first plate by deforming the flat integrated member with the first surface facing inward of a curved shape of the curved integrated member.

8. The method for producing a display apparatus according to claim 7, wherein
the flat liquid crystal panel has polarizing plates preliminarily bonded thereto at the first surface and the second surface.

9. The method for producing a display apparatus according to claim 7, wherein
the flat surface of the flat first plate is bonded to the first surface of the flat liquid crystal panel.

10. The method for producing a display apparatus according to claim 7, wherein
in the obtaining the flat integrated member,
flat second plates are placed on the second surface of the flat liquid crystal panel so that the flat second plates respectively cover a pair of opposed edge sections of the flat liquid crystal panel,
adhesive layers are formed between the flat first plate and the flat second plates in regions in which the flat liquid crystal panel is not present, and
the flat second plates are bonded to the flat first plate through the adhesive layers.

11. The method for producing a display apparatus according to claim 10, wherein
in the obtaining the flat integrated member, the flat second plates are a pair of bar-shaped members respectively extending along the pair of opposed edge sections.

12. The method for producing a display apparatus according to claim 11, wherein
in the obtaining the flat integrated member, the adhesive layers are formed along the pair of opposed edge sections.

13. The method for producing a display apparatus according to claim 10, wherein
in the obtaining the flat integrated member, the flat second plates are formed as a single member having substantially the same size as the flat first plate.

14. The method for producing a display apparatus according to claim 13, wherein
in the obtaining the flat integrated member, the adhesive layers are formed into a shape that surrounds the flat liquid crystal panel.

15. The method for producing a display apparatus according to claim 10, wherein
in the obtaining the flat integrated member, the flat second plates are joined to the pair of opposed edge sections.

16. The method for producing a display apparatus according to claim 7, wherein
the flat first plate is more rigid than the flat liquid crystal panel.

17. A display apparatus comprising:
a curved liquid crystal panel; and
a transparent curved first plate,
the curved liquid crystal panel including
a pair of curved glass substrates opposed to each other and
a liquid crystal enclosed between the pair of curved glass substrates,
the curved flat liquid crystal panel having
a first surface facing inward of a curved shape of the curved liquid crystal panel and serving as a display surface or a back surface and
a second surface being opposite to the first surface,
the curved first plate having a curved surface larger than the first surface, being disposed over the curved liquid crystal panel so that the curved surface covers the entirety of the first surface, and being curved along the curved liquid crystal panel, wherein
the curved first plate is more rigid than the curved liquid crystal panel.

18. The display apparatus according to claim 17, wherein
the curved liquid crystal panel has polarizing plates preliminarily bonded thereto at the first surface and the second surface.

19. The display apparatus according to claim 17, wherein
the curved surface of the curved first plate is bonded to the first surface of the curved liquid crystal panel.

20. The display apparatus according to claim 17, further comprising
curved second plates disposed on the second surface of the curved liquid crystal panel so that the curved second plates respectively cover a pair of opposed edge sections of the curved liquid crystal panel, wherein
the curved second plates are joined to the pair of opposed edge sections.

21. The display apparatus according to claim 17, wherein
the pair of curved glass substrates opposed to each other are not misaligned relative to each other in a direction of the curve.
